(19) United States
(12) Patent Application Publication
(10) Pub. No.: US 2026/0021560 A1
(43) Pub. Date: Jan. 22, 2026

(54) DOUBLE SUCTION CUP ASSEMBLY

(71) Applicant: PLUS CRAFT INDUSTRIAL CO., LTD., Taichung City (TW)

(72) Inventor: Timmy Chen, Taichung City (TW)

(21) Appl. No.: 18/777,016

(22) Filed: Jul. 18, 2024

(51) Int. Cl. B25B 11/00

(52) U.S. Cl. CPC B25B 11/007

(57) ABSTRACT

A double suction cup assembly includes a holding member, a first suction cup module, a driving member, a second suction cup module, and a driven member. The holding member includes a grip, a first seat, and a second seat. The first suction cup module is mounted on the first seat and driven by the driving member. The second suction cup module is mounted on the second seat and driven by the driven member. The driven member is driven by the driving member. Thus, the driving member drives the driven member to operate the first suction cup module and the second suction cup module simultaneously, and to form or release a vacuum state simultaneously.

### BACKGROUND OF THE INVENTION

### Field of the Invention

The present invention relates to a sucker holder and, more particularly, to a double suction cup assembly (or holder) or vacuum suction lifter.

### Description of the Related Art

A conventional double suction cup assembly in accordance with the prior art shown in FIGS. 1 and 2 comprises a grip 15, two seats 11, two suction cup members 12, two springs 13, and two drive members 14. The two seats 11 are mounted on two ends of the grip 15. Each of the seats 11 has a center provided with a hole 112 and has a top provided with a platform 111. Each of the suction cup members 12 has a top provided with a pull rod 122 which has an upper end provided with a perforation 123 allowing passage of a bolt 121. Each of the drive members 14 is provided with a pivot portion 141, a pivot hole 143 and an eccentric edge 142. Each of the springs 13 is mounted on the pull rod 122 of each of the suction cup members 12. The pull rod 122 of each of the suction cup members 12 extends through the hole 112 of each of the seats 11 so that each of the suction cup members 12 is mounted on the bottom of each of the seats 11. The bolt 121 extends through the pivot hole 143 of each of the drive members 14 and the perforation 123 of the pull rod 122 of each of the suction cup members 12, so that the pivot portion 141 of each of the drive members 14 is pivotally connected with the pull rod 122 of each of the suction cup members 12. Thus, each of the drive members 14 can be pivoted on each of the seats 11. The eccentric edge 142 of each of the drive members 14 rests on the platform 111 of each of the seats 11.

In operation, when each of the drive members 14 is driven, the eccentric edge 142 of each of the drive members 14 presses the platform 111 of each of the seats 11, and the pull rod 122 of each of the suction cup members 12 is pulled upward, so that each of the suction cup members 12 produces a vacuum suction force and is attached to an object, such as a sheet plate, a tile or a piece of glass. However, the user has to drive the drive members 14 to operate the suction cup members 12 respectively so that the conventional double suction cup assembly cannot be operated by the user's one hand only, thereby causing inconvenience to the user when operating the suction cup members 12.

### BRIEF SUMMARY OF THE INVENTION

The primary objective of the present invention is to provide a double suction cup assembly that is operated easily to generate or release a suction force simultaneously.

In accordance with the present invention, there is provided a double suction cup assembly comprising a holding member, a first suction cup module, a driving member, a second suction cup module, and a driven member. The holding member includes a grip having a first end extending downward and a second end extending downward, a first seat integrally formed on the first end of the holding member, and a second seat integrally formed on the second end of the holding member. The first seat has a first platform provided with a first passage. The second seat has a second platform provided with a second passage. The holding member has a first receiving chamber formed between the grip and the first seat. The first receiving chamber is hollow and has a sidewall provided with a positioning hole. The holding member has a second receiving chamber formed between the grip and the second seat. The second receiving chamber is hollow. The first suction cup module includes a first suction cup member having a flexible feature, a first pull rod protruding upward from the first suction cup member and having an upper end provided with a first perforation, a first shaft extending through the first perforation of the first pull rod, and a first spring member mounted on the first pull rod and biased between the first suction cup member and the first platform of the first seat. The first pull rod extends through the first passage of the first platform from a bottom of the first seat and partially extending into the first receiving chamber of the first seat. The driving member partially extends into the first receiving chamber of the first seat. The driving member has a first end having a bottom formed with an abutting edge. The driving member is provided with a limit groove arranged above the abutting edge. The driving member is provided with a limit hole. A control knob is movable into and received in the limit hole of the driving member. A spring is mounted on the control knob. The driving member has a second end provided with a pull handle. The second suction cup module includes a second suction cup member having a flexible feature, a second pull rod protruding upward from the second suction cup member and having an upper end provided with a second perforation, a second shaft extending through the second perforation of the second pull rod, and a second spring member mounted on the second pull rod and biased between the second suction cup member and the second platform of the second seat. The second pull rod extends through the second passage of the second platform from a bottom of the second seat and partially extending into the second receiving chamber of the second seat. The driven member partially extends into the second receiving chamber of the second seat. The driven member has a first end having a bottom formed with an abutting edge. The driven member is provided with a limit groove arranged above the abutting edge. The driven member has a second end provided with a driven portion.

According to the primary advantages of the present invention, the first suction cup module is mounted on the first seat and driven by the driving member, the second suction cup module is mounted on the second seat and driven by the driven member, and the driven member is driven by the driving member. Thus, the driving member drives the driven member to operate the first suction cup module and the second suction cup module simultaneously, and to form or release a vacuum state simultaneously.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional double suction cup assembly in accordance with the prior art.

FIG. 2 is a cross-sectional operational view of the conventional double suction cup assembly in accordance with the prior art.

FIG. 3 is a perspective view of a double suction cup assembly in accordance with the preferred embodiment of the present invention.

FIG. 4 is an exploded perspective view of the double suction cup assembly in accordance with the preferred embodiment of the present invention.

FIG. 5 is a perspective view of a driving member of the double suction cup assembly in accordance with the preferred embodiment of the present invention.

FIG. 6 is a perspective view of a driven member of the double suction cup assembly in accordance with the preferred embodiment of the present invention.

FIG. 7 is a cross-sectional view of the double suction cup assembly as shown in FIG. 3.

FIG. 8 is a schematic operational view of the double suction cup assembly as shown in FIG. 3.

FIG. 9 is a schematic operational view of the double suction cup assembly as shown in FIG. 7.

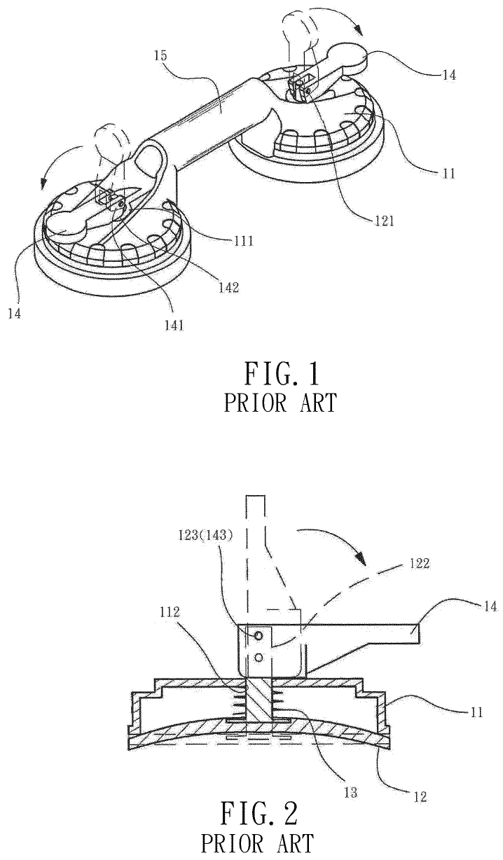

### DETAILED DESCRIPTION OF THE INVENTION

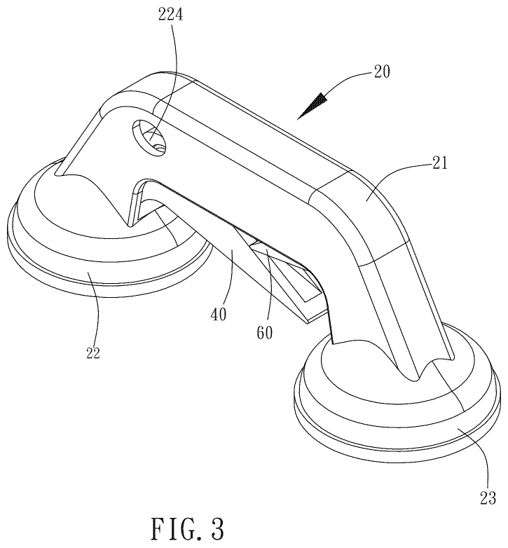

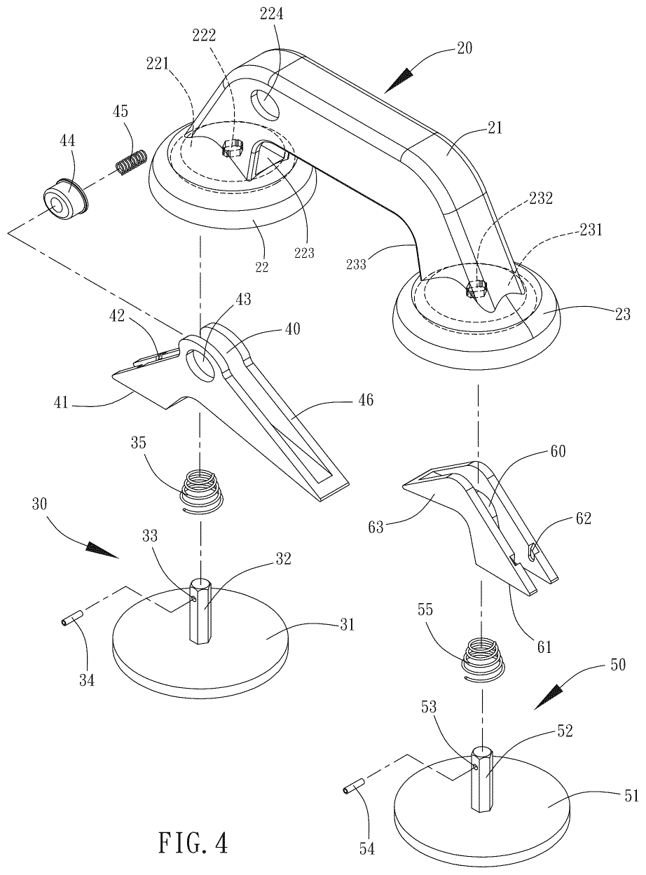

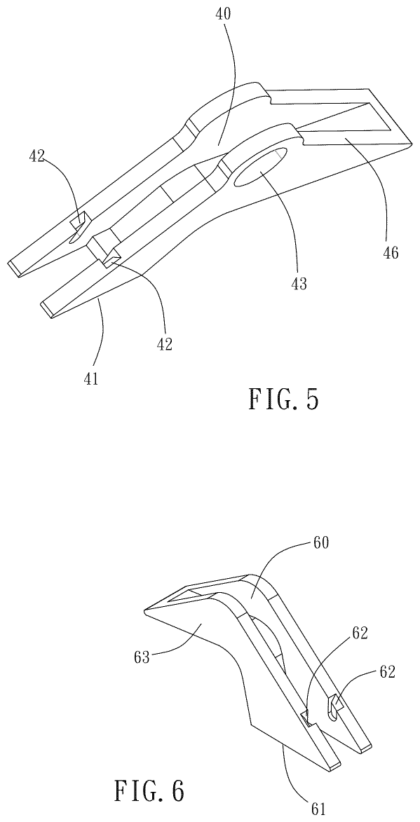

Referring to the drawings and initially to FIGS. 3-7, a double suction cup assembly in accordance with the preferred embodiment of the present invention comprises a holding member (or unit) 20, a first suction cup module 30, a driving member 40, a second suction cup module 50, and a driven member 60.

The holding member 20 includes a grip 21 having a first end extending downward and a second end extending downward, a first seat 22 integrally formed on the first end of the holding member 20, and a second seat 23 integrally formed on the second end of the holding member 20. The first seat 22 has a first platform 221 provided with a first passage 222. The second seat 23 has a second platform 231 provided with a second passage 232. The holding member 20 has a first receiving chamber 223 formed between the grip 21 and the first seat 22. The first receiving chamber 223 is hollow and has a sidewall provided with a positioning hole 224. The holding member 20 has a second receiving chamber 233 formed between the grip 21 and the second seat 23. The second receiving chamber 233 is hollow.

The first suction cup module 30 includes a first suction cup member 31 having a flexible feature, a first pull rod (or pole) 32 protruding upward from the first suction cup member 31 and having an upper end provided with a first perforation 33, a first shaft 34 extending through the first perforation 33 of the first pull rod 32, and a first spring member 35 mounted on the first pull rod 32 and biased between the first suction cup member 31 and the first platform 221 of the first seat 22. The first pull rod 32 extends through the first passage 222 of the first platform 221 from a bottom of the first seat 22 and partially extending into the first receiving chamber 223 of the first seat 22.

The driving member 40 partially extends into the first receiving chamber 223 of the first seat 22. The driving member 40 has a first end having a bottom formed with an abutting edge 41. The driving member 40 is provided with a limit groove 42 arranged above the abutting edge 41. The driving member 40 is provided with a limit hole 43. A control knob 44 is movable into and received in the limit hole 43 of the driving member 40. A spring 45 is mounted on the control knob 44. The driving member 40 has a second end provided with a pull handle 46.

The second suction cup module 50 includes a second suction cup member 51 having a flexible feature, a second pull rod (or pole) 52 protruding upward from the second suction cup member 51 and having an upper end provided with a second perforation 53, a second shaft 54 extending through the second perforation 53 of the second pull rod 52, and a second spring member 55 mounted on the second pull rod 52 and biased between the second suction cup member 51 and the second platform 231 of the second seat 23. The second pull rod 52 extends through the second passage 232 of the second platform 231 from a bottom of the second seat 23 and partially extending into the second receiving chamber 233 of the second seat 23.

The driven member 60 partially extends into the second receiving chamber 233 of the second seat 23. The driven member 60 has a first end having a bottom formed with an abutting edge 61. The driven member 60 is provided with a limit groove 62 arranged above the abutting edge 61. The driven member 60 has a second end provided with a driven portion 63.

In the preferred embodiment of the present invention, the first passage 222 has an inner diameter having a polygonal shape, and the first pull rod 32 has an outer diameter having a polygonal shape matching that of the first passage 222. In addition, the second passage 232 has an inner diameter having a polygonal shape, and the second pull rod 52 has an outer diameter having a polygonal shape matching that of the second passage 232.

In the preferred embodiment of the present invention, the abutting edge 41 of the driving member 40 presses the first platform 221, and the abutting edge 61 of the driven member 60 presses the second platform 231.

In the preferred embodiment of the present invention, the limit groove 42 of the driving member 40 is a blind slot that is tapered from an open top (or entrance) toward a closed bottom (or limit end).

In the preferred embodiment of the present invention, the limit groove 62 of the driven member 60 is a blind slot that is tapered from an open top (or entrance) toward a closed bottom (or limit end).

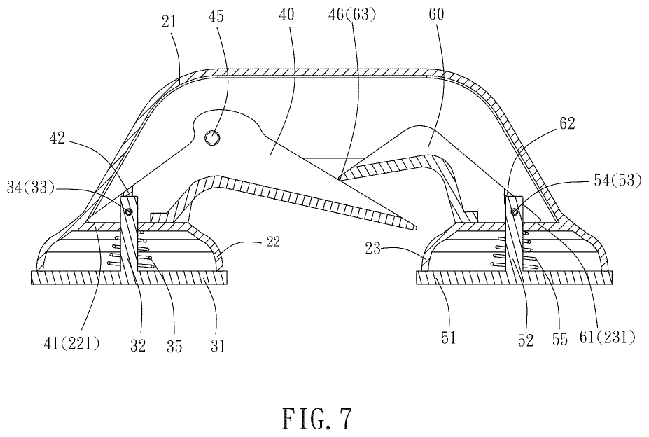

In the preferred embodiment of the present invention, the driven portion 63 of the driven member 60 presses a top of the pull handle 46 of the driving member 40 as shown in FIG. 7.

In the preferred embodiment of the present invention, the first platform 221 is formed on a top of the first seat 22 and located in the first end of the holding member 20, and the second platform 231 is formed on a top of the first seat 22 and located in the second end of the holding member 20.

In the preferred embodiment of the present invention, the first shaft 34 is movably limited in the limit groove 42 of the driving member 40, and the second shaft 54 is movably limited in the limit groove 62 of the driven member 60.

In the preferred embodiment of the present invention, the first suction cup member 31 is mounted on the bottom of the first seat 22, and the second suction cup member 51 is mounted on the bottom of the second seat 23.

In the preferred embodiment of the present invention, the limit groove 42 of the driving member 40 is formed in two opposite sides of the driving member 40 for mounting two ends of the first shaft 34, and the limit groove 62 of the driven member 60 is formed in two opposite sides of the driven member 60 for mounting two ends of the second shaft 54.

In the preferred embodiment of the present invention, the control knob 44 rests on an inside of the first receiving chamber 223.

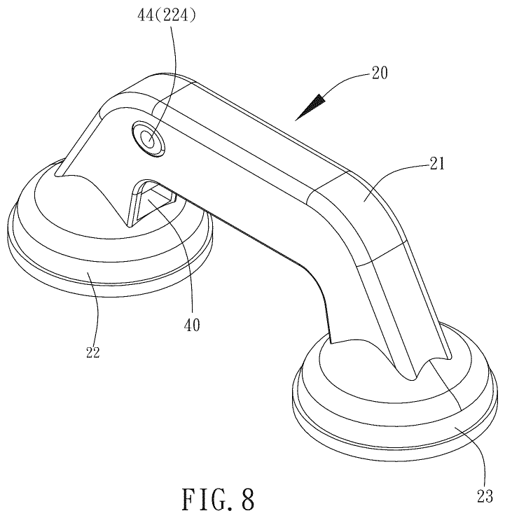

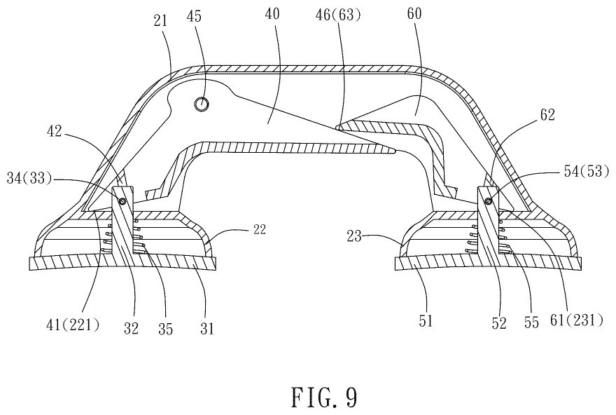

In operation, referring to FIGS. 8 and 9 with reference to FIGS. 3-7, when the double suction cup assembly is to be adhered to a plane (or sheet plate), the first suction cup member 31 and the second suction cup member 51 are placed on the plane. When the pull handle 46 of the driving member 40 is driven upward, the abutting edge 41 of the driving member 40 presses and pushes the upper surface of the first platform 221 of the first seat 22, and the driving member 40 is rotated and moved, with the abutting edge 41 served as a middle point or fulcrum, so that the limit groove 42 of the driving member 40 is also moved. At this time, the first shaft 34 of the first suction cup module 30 is limited in the limit groove 42 of the driving member 40, so that the first shaft 34 is moved upward by the driving member 40, and the first pull rod 32 is pulled upward by the first shaft 34. In such a manner, the first suction cup member 31 is pulled upward by the first pull rod 32. At this time, the periphery of the first suction cup member 31 is stopped by the first seat 22 so that the first suction cup member 31 forms a vacuum arc and is attached to the plane. At this time, the control knob 44 is rotated with the driving member 40 and moved to align with the positioning hole 224 of the first receiving chamber 223 so that the control knob 44 is pushed by the restoring force of the spring 45 and is positioned in the positioning hole 224 as shown in FIG. 8. Thus, the first suction cup member 31 is adhered to the plane exactly.

At the same time, when the driving member 40 is driven upward, the pull handle 46 of the driving member 40 is moved upward so that the driven portion 63 of the driven member 60 is also moved upward, to drive and pivot the driven member 60 as shown in FIG. 9. When the driven member 60 is driven upward, the driven member 60 presses and pushes the upper surface of the second platform 231 of the second seat 23, and is rotated and moved, with the abutting edge 61 served as a middle point or fulcrum, so that the limit groove 62 of the driven member 60 is also moved. At this time, the second shaft 54 of the second suction cup module 50 is limited in the limit groove 62 of the driven member 60, so that the second shaft 54 is moved upward by the driven member 60, and the second pull rod 52 is pulled upward by the second shaft 54. In such a manner, the second suction cup member 51 is pulled upward by the second pull rod 52. At this time, the periphery of the second suction cup member 51 is stopped by the second seat 23 so that the second suction cup member 51 forms a vacuum arc and is attached to the plane.

Thus, the driving member 40 is driven upward, the driven member 60 is also driven upward, so that the first suction cup member 31 and the second suction cup member 51 form a vacuum state simultaneously and are adhered to the plane exactly.

On the contrary, when the control knob 44 is pushed, the spring 45 is compressed, and the control knob 44 is detached from the positioning hole 224. At this time, the driving member 40 is driven by the restoring force of the first spring member 35, so that the driving member 40 is moved and returned to the original position, and the control knob 44 is moved to rest on the inside of the first receiving chamber 223. In addition, the pressure applied on the first suction cup member 31 disappears, so that the first suction cup member 31 is moved and returned to the original position, to release the vacuum suction state. When the driving member 40 is returned to the original position, the driven member 60 is released from the driving member 40, and is driven by the restoring force of the second spring member 55, so that the driven member 60 is moved and returned to the original position. In addition, the pressure applied on the second suction cup member 51 disappears, so that the second suction cup member 51 is moved and returned to the original position, to release the vacuum suction state.

Accordingly, the user only needs to pull the driving member 40 to trigger the vacuum state of the first suction cup member 31 and the second suction cup member 51 or to push the control knob 44 to release the vacuum state of the first suction cup member 31 and the second suction cup member 51, so that the double suction cup assembly can be operated simultaneously by the user's one hand and saves the user's energy and time. In addition, the limit groove 42 of the driving member 40 is a blind slot that is tapered from the entrance toward the limit end so that the first shaft 34 is guided and moved easily and smoothly into the limit groove 42 of the driving member 40. Further, the limit groove 62 of the driven member 60 is a blind slot that is tapered from the entrance toward the limit end so that the second shaft 54 is guided and moved easily and smoothly into the limit groove 62 of the driven member 60.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A double suction cup assembly comprising:
a holding member, a first suction cup module, a driving member, a second suction cup module, and a driven member;
wherein:
the holding member includes a grip having a first end extending downward and a second end extending downward, a first seat integrally formed on the first end of the holding member, and a second seat integrally formed on the second end of the holding member;
the first seat has a first platform provided with a first passage;
the second seat has a second platform provided with a second passage;
the holding member has a first receiving chamber formed between the grip and the first seat;
the first receiving chamber is hollow and has a sidewall provided with a positioning hole;
the holding member has a second receiving chamber formed between the grip and the second seat;
the second receiving chamber is hollow;
the first suction cup module includes a first suction cup member having a flexible feature, a first pull rod protruding upward from the first suction cup member and having an upper end provided with a first perforation, a first shaft extending through the first perforation of the first pull rod, and a first spring member mounted on the first pull rod and biased between the first suction cup member and the first platform of the first seat;
the first pull rod extends through the first passage of the first platform from a bottom of the first seat and partially extending into the first receiving chamber of the first seat;
the driving member partially extends into the first receiving chamber of the first seat;
the driving member has a first end having a bottom formed with an abutting edge;
the driving member is provided with a limit groove arranged above the abutting edge;
the driving member is provided with a limit hole;
a control knob is movable into and received in the limit hole of the driving member;
a spring is mounted on the control knob;
the driving member has a second end provided with a pull handle;
the second suction cup module includes a second suction cup member having a flexible feature, a second pull rod protruding upward from the second suction cup member and having an upper end provided with a second perforation, a second shaft extending through the second perforation of the second pull rod, and a second spring member mounted on the second pull rod and biased between the second suction cup member and the second platform of the second seat;
the second pull rod extends through the second passage of the second platform from a bottom of the second seat and partially extending into the second receiving chamber of the second seat;
the driven member partially extends into the second receiving chamber of the second seat;
the driven member has a first end having a bottom formed with an abutting edge;
the driven member is provided with a limit groove arranged above the abutting edge; and
the driven member has a second end provided with a driven portion.

2. The double suction cup assembly as claimed in claim 1, wherein the first passage has an inner diameter having a polygonal shape, the first pull rod has an outer diameter having a polygonal shape matching that of the first passage, the second passage has an inner diameter having a polygonal shape, and the second pull rod has an outer diameter having a polygonal shape matching that of the second passage.

3. The double suction cup assembly as claimed in claim 1, wherein the abutting edge of the driving member presses the first platform, and the abutting edge of the driven member presses the second platform.

4. The double suction cup assembly as claimed in claim 1, wherein the limit groove of the driving member is a blind slot that is tapered from an open top toward a closed bottom.

5. The double suction cup assembly as claimed in claim 1, wherein the limit groove of the driven member is a blind slot that is tapered from an open top toward a closed bottom.

6. The double suction cup assembly as claimed in claim 1, wherein the driven portion of the driven member presses a top of the pull handle of the driving member.
